(19) United States
(12) Patent Application Publication
(10) Pub. No.: US 2006/0269175 A1
(43) Pub. Date: Nov. 30, 2006

(54) Low-friction linear motion apparatus

(76) Inventor: Pei-Jen Lin, Taipei (TW)

Correspondence Address: BIRCH STEWART KOLASCH & BIRCH, PO BOX 747, FALLS CHURCH, VA, 22040-0747, US

(21) Appl. No.: 11/431,553

(22) Filed: May 11, 2006

(30) Foreign Application Priority Data
May 13, 2005 (TW) 094207794

(51) Int. Cl. F16C 29/00; F16C 17/00; F16C 21/00

(52) U.S. Cl. 384/26; 384/42

(57) ABSTRACT

A low-friction linear motion apparatus includes a track bar having two parallel guide rails on two opposite sides thereof, and a sliding member forming a mating cavity on two opposite undersides thereof and provided with multiple bearing rods on the mating cavities, which rest against the guide rails when the sliding member is slidably fitted over the track bar. At least one side of the sliding member is installed with a clamping device/holder to adjust the interval between the bearing rods and guide rails for minimal friction. Each guide rail is partially set in a parallel slot on each side wall of the track bar and partially exposed for resting against the bearing rods. The sliding member can move along the longitudinal direction of the track bar with little friction due to line contacts or non-circulating point contacts.

### BACKGROUND OF THE INVENTION

1. Field of the Invention

The present invention relates generally to a low-friction linear motion apparatus that has a guide structure to provide with a relative linear motion of two objects by means of line contact or surface contact, and a self-alignment mechanism to automatically adjust contact position between components.

2. The Related Art

Referring to FIG. 1, a conventional linear motion apparatus provides with a relative linear motion of a sliding member and a guide track, which has a guide structure with low resistance. In this structure, balls are assembled between the sliding member and the guide track in a circulating pattern to reduce friction between their contact surfaces due to point contacts.

Although the point contacts can provide a significant reduction in friction between two contact surfaces, its components cannot bear with a larger impact, thereby being easily damaged. Further, when the balls circularly move, it is easy to generate vibration.

Further, the conventional linear motion apparatus has not a self-alignment mechanism to correct any shifts and tilting problem that may result from machining errors or deformation. It will generate a shift of contact points. Accordingly, all loads are borne on diagonal balls and guide grooves, thereby reducing its service life.

Another problem of the conventional linear motion apparatus is that the apparatus has not a pressure-adjusting mechanism to adjust the distance between the bearing rods. This may also affect the service life of the parts.

Still another problem of the conventional linear motion apparatus is that the guide track and the guide rail are formed as one-piece, thereby making it difficult to handle in subsequent process. The guided track is easily deformed or warped during heat treatment and grinding processes. Therefore, the assembling requires certain skilled person in order to prevent the problems described above.

Thus, it is desired to provide a low-friction linear motion apparatus that can substantially reduces or obviates the limitations and disadvantages of the prior art.

### SUMMARY OF THE INVENTION

A primary objective of the present invention is to provide a low-friction linear motion apparatus that makes use of line contacts or non-circulating point contacts of multiple guide rails and bearing rods, thereby enabling the linear motion apparatus to bear greater load and extend the service life.

A second objective of the present invention is to provide a low-friction linear motion apparatus that provides micro-adjustment of the interval between the bearing rods and guide rails to correct factory alignment errors.

A third objective of the present invention is to provide a low-friction linear motion apparatus that provides micro-adjustment of the distance between two rows of bearing rods to match the load requirement so that the resultant friction can be controlled at a minimal level.

A fourth objective of the present invention is to provide a low-friction linear motion apparatus that incorporates a parallel slot on each side of the track bar to facilitate the mounting of the guide rail obviating the use of the heat treatment and polishing processes, thus enabling easy assembling at reduced costs.

The low-friction linear motion apparatus includes a track bar with two guide rails on its two sides running through the full length of the track, and a sliding member which is supported by multiple bearing rods, which are arranged in two row format on two shoulder walls of the sliding member with a mating cavity, corresponding to the positions of the guide rails. Each guide rail is partially set in a parallel slot on the side wall of the track bar and partially exposed with outward curved surface to provide sliding contacts with the bearing rods also bulging out on the opposite surface when the sliding member is slidably assembled. The bearing rods rest against the bearing rails by line contact or non-circulating point contact with each other and slidably move in longitudinal direction, which will not generate welding phenomena.

The low-friction linear motion apparatus according to the present invention can prevent the deformation of the bearings, and minimize thermal heat accumulation due to friction between two contact surfaces.

The present invention is characterized in that the sliding contact portions of the guide rails and the bearing rods are made of different materials. The guide rails may be made of metal while the bearing rods may be made of ceramic material, so that the contact surfaces will not be welded under high operating temperature.

The present invention is also characterized in that the distance between the two-row bearing rods shall always be less than the diameter of the corresponding guide rail to enable a tight fit between the two-row bearing rods.

These along with other features of novelty, which characterize the present invention, are pointed out with particularity in the claims annexed to and forming a part of this disclosure. For a better understanding of the invention, the operating advantages and the specific objectives attained by its uses, references should be made to the accompanying drawings and descriptive matter illustrated in preferred embodiments of the present invention.

### BRIEF DESCRIPTION OF THE DRAWINGS

FIG. 1 is a perspective view of a conventional sliding apparatus;

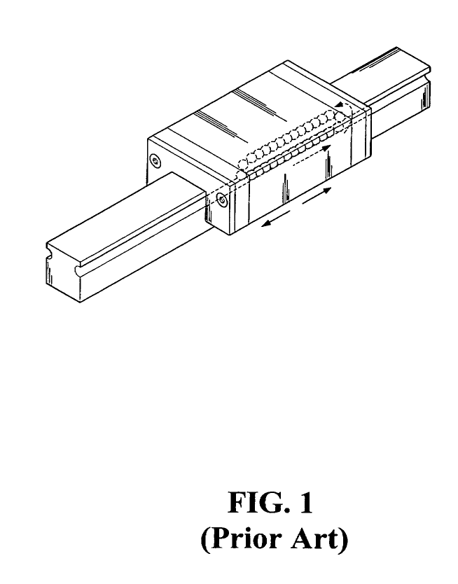

FIG. 2 is an exploded view of a low-friction linear motion apparatus according to a first embodiment of the present invention;

FIG. 3 is a sectional view of FIG. 2;

FIG. 4 is an exploded view of a low-friction linear motion apparatus according to a second embodiment of the present invention;

FIG. 5 is an exploded view of a low-friction linear motion apparatus according to a third embodiment of the present invention;

FIG. 6 is an exploded view of a low-friction linear motion apparatus according to a fourth embodiment of the present invention;

FIG. 7 is an exploded view of a low-friction linear motion apparatus according to a fifth embodiment of the present invention;

FIG. 8 is an exploded view of a low-friction linear motion apparatus according to a sixth embodiment of the present invention;

FIG. 9 is an end view of a low-friction linear motion apparatus according to a seventh embodiment of the present invention;

FIG. 10 is an end view of a low-friction linear motion apparatus according to an eighth embodiment of the present invention;

FIG. 11 is an exploded view of a low-friction linear motion apparatus according to a ninth embodiment of the present invention;

FIG. 12 is an end view of a the low-friction linear motion apparatus according to a tenth embodiment of the present invention; and

FIG. 13 is an end view of a low-friction linear motion apparatus according to an eleventh embodiment of the present invention.

### DETAILED DESCRIPTION OF THE PREFERRED EMBODIMENT

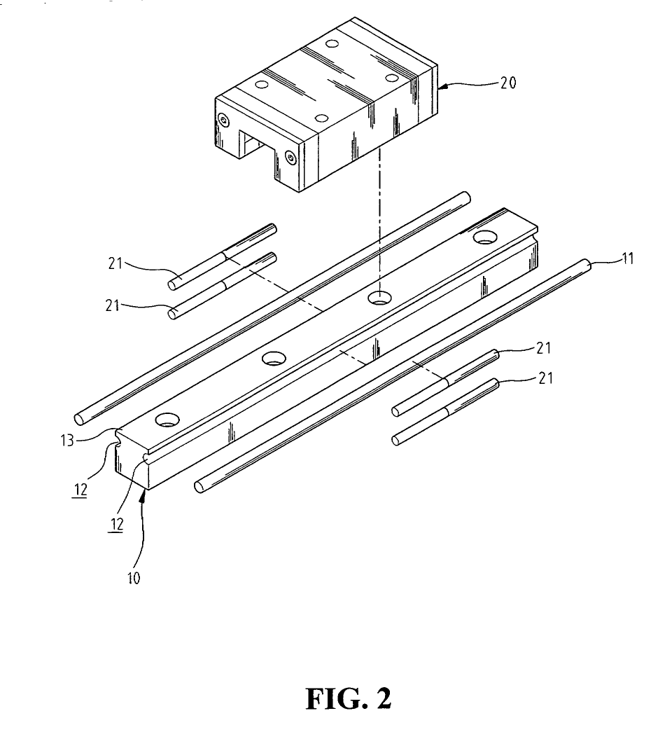

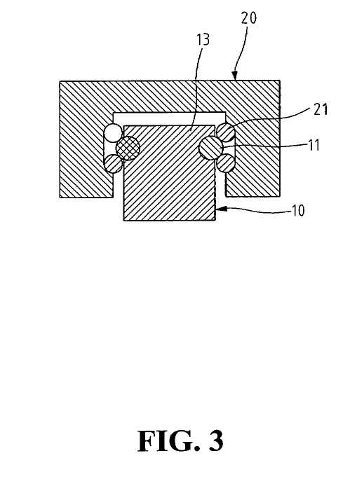

Referring to FIGS. 2 and 3, a low-friction linear motion apparatus in accordance with a first embodiment of the present invention comprises a track bar 10 and a sliding member 20 mounted on the track bar 10, which provide with a relative linear motion of two objects. The sliding member 20 moves along the track bar 20, two contact surfaces of which have different materials with minimal friction.

The track bar 10 has two parallel guide rails 11 on its two sides. Each guide rails 11 is partially set in a parallel slot on each side of the track bar 10 and partially exposed with outward curved surface.

The sliding member 20 has a mating cavity on its underside, in which two rows of bearing rods 21 are attached on each shoulder wall of the mating cavity. When the linear motion apparatus is assembled, the two-row bearing rods 21 on each side is slidably fitted onto the guide rail 11 of the sliding member 20 on the same side, thereby providing line contacts for linear motion of the sliding member 20 along the track bar 10.

The guide rails 11 and bearing rods 21 are used on two sides to support the thrust load over the sliding member 20, wherein the number of guide rails 11 for the linear motion apparatus may vary depending on the row number of bearing rods 21 used for supporting the sliding member 20, and the choice of using guide rails on one side or two sides also depends on the design requirements.

In the first embodiment, each guide rail 11 is fitted into a parallel slot 12 on each side of the track bar 10, where each guide rail 11 is a tubular body running through the full length of the track bar 10. The sliding member 20 has a mating cavity on an under side thereof, in which two rows of bearing rods 21 are mounted on an inner surface of each shoulder wall of the cavity, where each bearing rod 21 is also a tubular body limited by the length of the sliding member 20.

The distance between the two-row bearing rods 21 is always less than the diameter of the corresponding guide rail 11; thereby enabling the guide rail 11 to tightly fit between the two-row bearing rods 21.

The sliding contact portions between the guide rails 11 and the bearing rods 21 shall be made of different materials. For example, the guide rail 11 may be made of metal while the bearing rod 21 may be made of ceramic material, so that the contact surfaces will not be welded under high operating temperature.

When assembled, each outward curved guide rail 11 is fitted in the gap between two-row bearing rods 21 on the same side of the sliding member 20. The bearing rods 21 and the guide rails 11 rest against each other to support linear motion of the sliding member 20 carrying a load along the track bar 10.

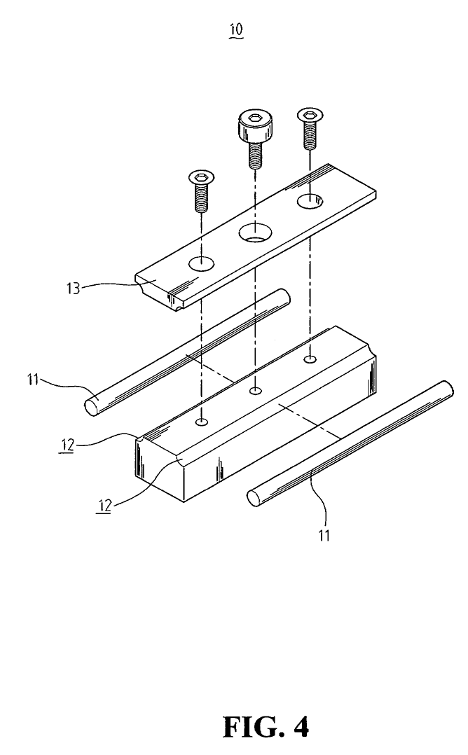

Referring to FIG. 4, the track bar 10 in accordance with a second embodiment of the present invention includes a cover strip 13 mounted thereon by multiple screws inserted through holes on a top of the cover strip 13, so as to form a parallel slot 12 on each side of the track bar 10. The parallel slot 12 is to receive a guide rail 11 running through the full length of the track bar 10. These two guide rails 11 on two sides of the track bar 10 are fixed in the parallel slots 13. The overall structure and the rest of components of the linear motion apparatus are identical to those in the first embodiment.

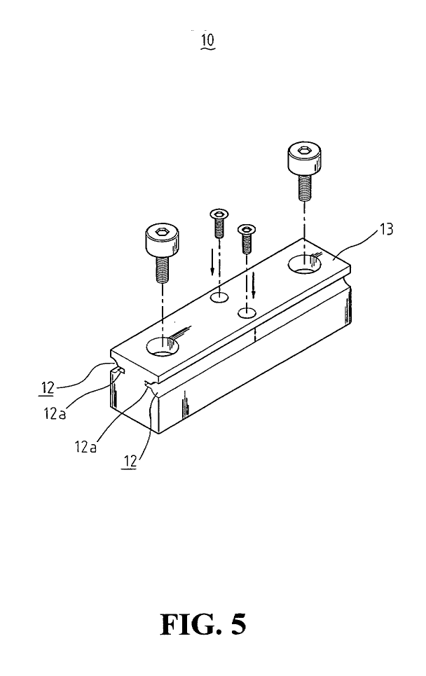

Referring to FIG. 5, the track bar 10 in accordance with a third embodiment of the present invention is an integral unit, whereas the track bar 10 in the second embodiment is formed of a one-piece bar with screws. The two parallel slots 12 each have a deep groove 12a at the innermost depth running in parallel with the slot 12 and through the full length of the track bar 10. Therefore, these two deep grooves 12a create an overhang portion 13 at a top of the track bar 10.

To assemble the track bar 10, the guide rail 11 is first placed into the slots 12 on each side of the track bar 10, and then multiple screws are inserted through top holes of the track bar 10 to clamp down the guide rails 11 by pressing the overhang portion 13 against the tubular guide rails 11 partially held in the parallel slots 12. As such, the guide rails 11 running through the track bar 10 can be micro-adjusted by loosening or tightening of the screws to control the interval and line contacts between the guide rails 11 and the bearing rods 21. Only the unique features of this embodiment are illustrated herein, while the overall structure and the rest of components are identical to those in previous embodiments.

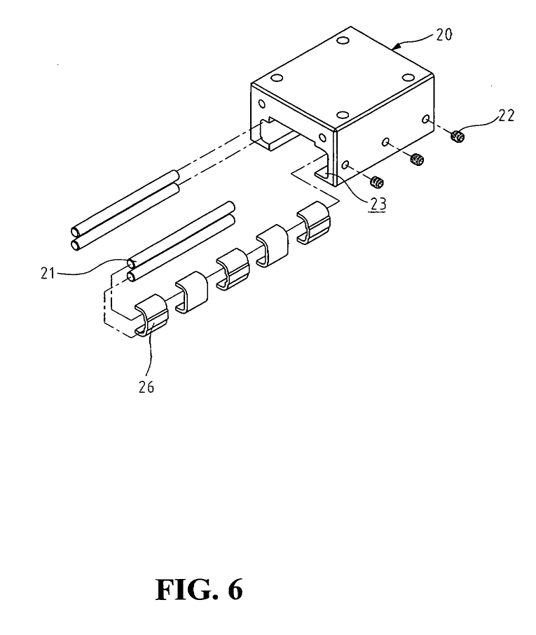

Referring to FIG. 6, the sliding member 20 in accordance with a fourth embodiment of the present invention includes multiple clamping devices 26 and screws 22 to position the bearing rods 21 with high precision. The clamping devices 26 are lined up against a dugout portion 23 in the mating cavity of the sliding member 20, and then screws 22 are inserted through corresponding holes on a side wall of the sliding member 20 to fix the clamping devices 26 in place. Each U-shaped clamping device 26 has grooves on an inner surface to receive the bearing rods 21. As such, the positions of the bearing rods 21 relative to the guide rails 11 can be micro-adjusted by loosening or tightening of the screws 22 in order to reduce the friction between contact surfaces.

The sliding contact surfaces on the mating cavity of the sliding member 20 can be lubricated by oily substance, so that friction between the guide rails 11 and the bearing rods 21 can be further reduced for better performance.

The clamping devices 26 can be installed either on one side or two sides of the sliding member 20, depending on the design requirement of the linear motion apparatus. Only the unique features of this embodiment are illustrated herein, while the overall structure and the rest of components are identical to those in previous embodiments.

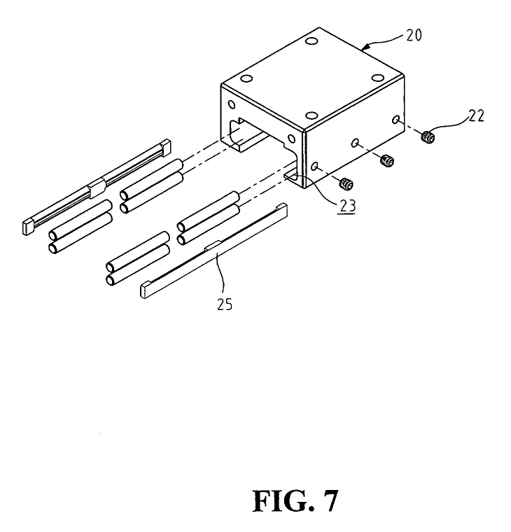

Referring to FIG. 7, the sliding member 20 in accordance with a fifth embodiment of the present invention includes two holders 25 and multiple screws 22 to position the bearing rods 21 with high precision. The holder 25 is a long narrow strip disposed parallel to the bearing rods 21, which are lined up on the dugout portion 23 in the mating cavity of the sliding member 20, and then multiple screws 22 are inserted through corresponding holes on a side wall of the sliding member 20 to fix the holders 25 in place. The surface of each holder 25 has multiple grooves that are either caved inward or slanted for securing the bearing rods 21.

As such, the positions of the bearing rods 21 relative to the guide rails 11 can be micro-adjusted for minimal friction in the linear motion of the sliding member 20, and the distance between the two rows of bearing rods 21 can be set accurately. The choice to use the holder 25 either on one side or two sides of the sliding member 10 depends on the design requirements. Only the unique features of this embodiment are illustrated herein, while the overall structure and the rest of components are identical to those in previous embodiments.

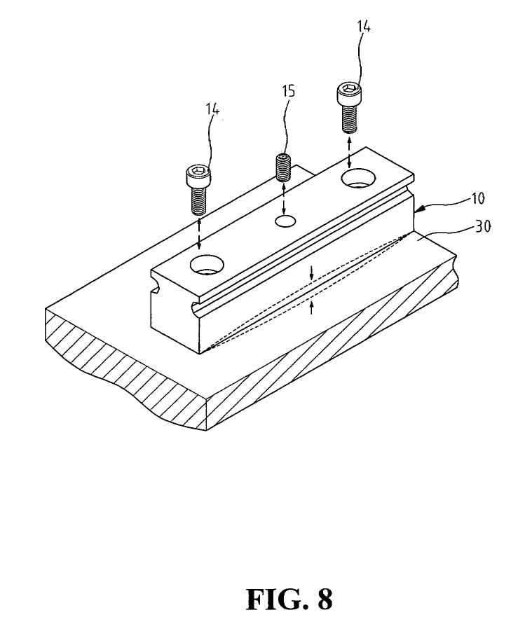

Referring to FIG. 8, the track bar 10 in accordance with a sixth embodiment of the present invention uses first screws 14 and second screws 15 to align the track bar 10 on a substructure 30. The first screws 14 are directly locked onto the substructure 30, while the second screws 15 are mounted vertically through the track bar 10, with the tip touching a surface of the substructure 30. As such, when a second screw 15 is driven deep into the track bar 10, the tip of the second screw 15 is acted against the surface of the substructure 30 to create a counter-action force to pull the track bar 10 away from the substructure 30.

Through this mechanism, the height of the track bar 10 can be micro-adjusted to correct slightly its deformation. Only the unique features of this embodiment are illustrated herein, while the structures and the rest of components identical to those in previous embodiments will not be reiterated.

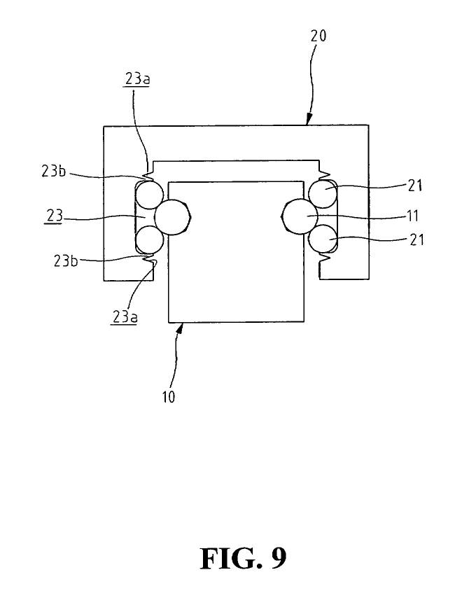

Referring to FIG. 9, the sliding member 20 in accordance with a seventh embodiment of the present invention includes two troughs 23a and spurs 23b in the dugout portion 23 of the mating cavity for placing the bearing rods 21 with extra flexibility. These troughs 23a and spurs 23b are formed on upper and lower ends to correct any disalignment between the guide rails 11 and the bearing rods 21, so that the positions of the bearing rods 21 and the guide rails 11 can be controlled to exact point contacts. Only the unique features of this embodiment are illustrated herein, while the overall structure and the rest of components are identical to those in previous embodiments.

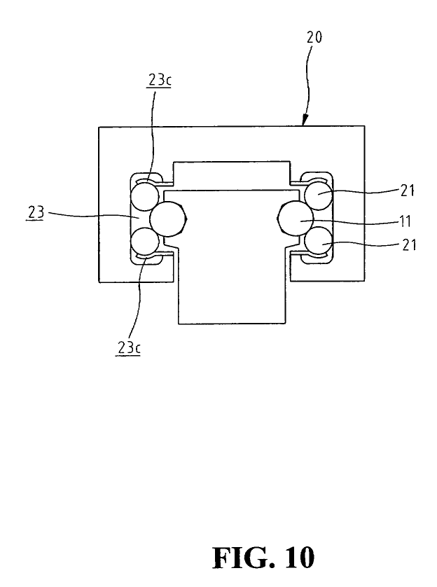

Referring to FIG. 10, the sliding member 20 in accordance with an eighth embodiment of the present invention includes two resilient clips 23c in the dugout portion 23 of the mating cavity for placing the bearing rods 21 with extra flexibility. A pair of resilient clips 23c is installed on upper and lower ends of the mating cavity, which replaces with the troughs 23a and spurs 23b in previous cases. Through this mechanism, the positions of the bearing rods 21 relative to the guide rails 11 can be micro-adjusted to exact point contacts. Only the unique features of this embodiment are illustrated herein, while the overall structure and the rest of components are identical to those used in previous embodiments.

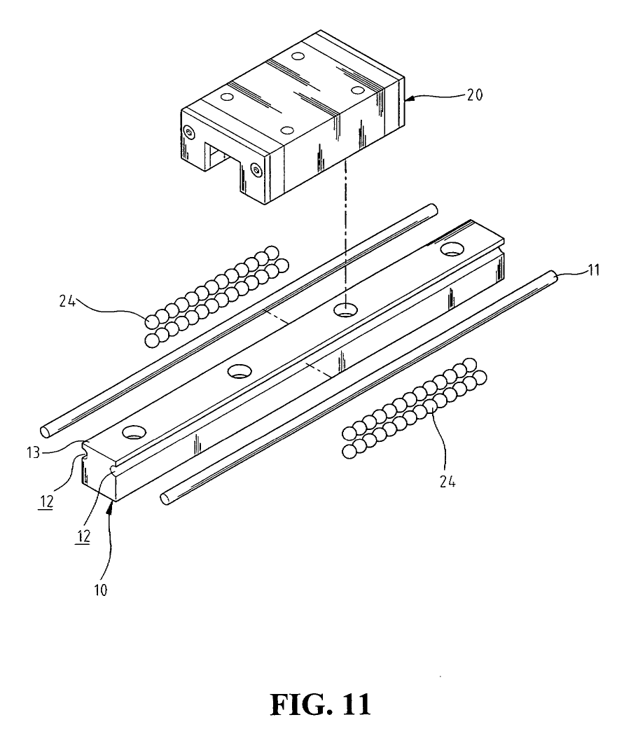

Referring to FIG. 11, the sliding member 20 of the linear motion apparatus in accordance with a ninth embodiment of the present invention includes two rows of ball bearings 24 lining the inner walls on the two sides. These ball bearings 24 are to replace the bearing rods 21 as used in all previous embodiments, which are non-circulating ball bearings that rotate in the same direction as the linear motion of the sliding member 20. Only the unique features of this embodiment are illustrated herein, while the structures and the rest of components are identical to those in previous embodiments.

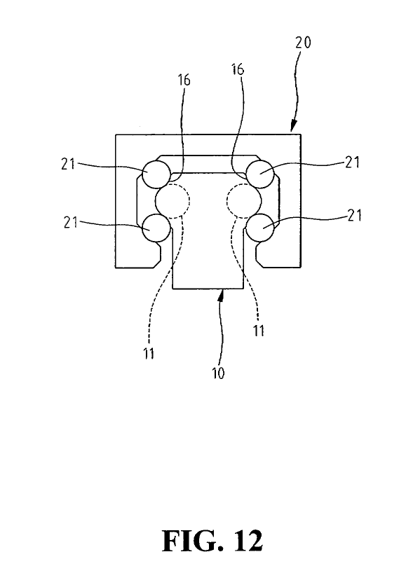

Referring to FIG. 12, the guide rails 11 and the track bar 10 in accordance with a tenth embodiment of the present invention are formed as an integral unit. There are two parallel tracks 16 on each side of the guide rail 11. The parallel tracks 16 rest against the bearing rods 21 when the sliding member 20 is slidably fitted onto the track bar 10. Only the unique features of this embodiment are illustrated herein, while the structures and the rest of components are identical to those in previous embodiments.

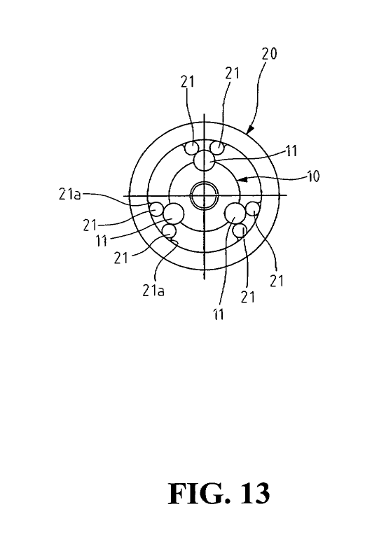

Referring to FIG. 13, the track bar 10 in accordance with an eleventh embodiment of the present invention is a cylindrical shaft, and the sliding member 20 is a cylindrical shell fitted around the track bar 10 to form a concentric cylindrical configuration. Multiple guide rails 11 mounted on a circumference of the cylindrical track bar 10 can be arranged to form a ring shape, triangular, quadrangular, or other polygonal shape, depending on the design requirements.

The sliding member 20 has multiple catch grooves 21a on an inner surface thereof for placing corresponding bearing rods 21, and the track bar 10 has multiple parallel slots on a circumference thereof for holding the guide rails 11. When the cylindrical sliding member 20 is slid over the track bar 10, the bearing rods 21 rest against the guide rails 11 to form sliding contacts for linear motion of the sliding member 20.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A low-friction linear motion apparatus, comprising:
a track bar having two parallel guide rails mounted on two opposite sides thereof;
a sliding member forming a mating cavity on two opposite undersides thereof and provided with multiple bearing rods on the mating cavities, which rest against the guide rails when the sliding member is slidably fitted over the track bar;
wherein the distance between adjacent bearing rods is less than the diameter of the guide rail; and
the bearing rods rest against the guide rails to form line contacts for the linear motion of the sliding member along the track bar.

2. The linear motion apparatus as claimed in claim 1, wherein multiple clamping devices, being a U-shape, are installed on at least one side of the sliding member, which are used for clamping the bearing rods.

3. The linear motion apparatus as claimed in claim 2, wherein multiple screws are used for mounting the clamping devices on an inner wall of the sliding member, which serve to control the interval and friction between the guide rails and the bearing rods.

4. The linear motion apparatus as claimed in claim 2, wherein the clamping devices are installed on one side of the sliding member.

5. The linear motion apparatus as claimed in claim 2, wherein the clamping devices are installed on two sides of the sliding member.

6. The linear motion apparatus as claimed in claim 1, wherein at least one holder is installed on at least one side of the sliding member, where the surface of each holder has multiple grooves that are either inward curved or slanted for locating the bearing rods.

7. The linear motion apparatus as claimed in clam 6, wherein multiple screws are used for mounting the holder on the inner wall of the sliding member, which serve to control the interval and friction between the guide rail and the bearing rods.

8. The linear motion apparatus as claimed in claim 6, wherein the holder is installed on one side of the sliding member.

9. The linear motion apparatus as claimed in claim 6, wherein the holder is installed on two sides of the sliding member.

10. The linear motion apparatus as claimed in claim 1, wherein multiple first and second screws are mounted on a top surface of the sliding member for securing the track bar on a substructure and correcting the track alignment.

11. The linear motion apparatus as claimed in claim 1, wherein the bearing rods are ball bearings.

12. The linear motion apparatus as claimed in claim 1, wherein the guide rails and the track bar can be formed as an integral unit.
